(19) United States
(12) Patent Application Publication
(10) Pub. No.: US 2012/0231669 A1
(43) Pub. Date: Sep. 13, 2012

(54) CIRCUIT BOARD CONNECTOR AND CONNECTING METHOD OF CIRCUIT BOARD

(75) Inventors: Pi LIN, Beijing (CN); Xiyong TIAN, Beijing (CN)

(73) Assignee: SONY ERICSSON MOBILE COMMUNICATIONS AB, Lund (SE)

(21) Appl. No.: 13/414,773

(22) Filed: Mar. 8, 2012

(30) Foreign Application Priority Data
Mar. 11, 2011 (CN) 201110059913.7

(51) Int. Cl. H01R 24/60

(52) U.S. Cl. 439/635

(57) ABSTRACT

The invention provides a circuit board connector and a connecting method for the circuit board. The circuit board connector includes an insulation housing, having opposed left and right side walls and a bottom wall arranged between the left and right side walls, the left and right side walls and bottom wall forming an accommodating space accommodating a circuit board; terminals arranged on the bottom wall of the insulation housing, the terminals having contact portions within the accommodating space; runners arranged in parallel at the left and right side walls of the insulation housing; and a sliding cover body, with the two ends of the sliding cover body connected to the runners and sliding along the runners. Reliable connection of the circuit board may be realized with no need of a gasket or a film, and without need of an extra space.

### TECHNICAL FIELD

The present invention relates to a circuit board connector and in particular, to a circuit board connector having a sliding structure, and a connecting method of circuit board.

### BACKGROUND ART

As communication technologies develop, mobile communication apparatus and various personal terminal devices, such as a mobile phone, personal digital assistant (PDA), and MP3/MP4, etc., are widely used. Flexible printed circuit (FPC) connectors are used to realize signal connection or transmission between various functional modules of these devices, or between these devices and external devices.

For example, an existing mobile phone usually includes a housing, a communication module, a human interface, and a power supply module, wherein the communication module is provided inside the housing, and the human interface usually includes a liquid crystal display screen arranged on the housing and electrically connected to the host circuit board via an FPC connector.

FIG. 1 is a schematic diagram showing a state in which a prior art FPC connector 100 has not been fully coupled to a flexible printed circuit board as in the prior art. As shown in FIG. 1, the FPC connector 100 includes an insulation housing 101 and a cover body 102, an accommodating space 105 being formed within the insulation housing 101, and a plurality of terminals 103 being arranged on the cover body 102, with each of the terminals having a contact portion 104. The flexible printed circuit board (not shown) may be connected to the FPC connector through extending into the accommodating space 105, and the conductive pins on the flexible printed circuit board may correspond to the terminals 103 on the cover body 102 and connect to respective contact portions 104. The cover body 102 is of a hinge structure, with the two ends being provided with a pivot, which is pivoted to a shaft hole of the insulation housing 101, thereby the cover body 102 may be opened or closed with respect to the insulation housing 101.

FIG. 2 is a schematic diagram showing a state in which an FPC connector cover body 102 has been rotated to be fully coupled to a flexible printed circuit board (not shown) as in the prior art. As shown in FIG. 2, after an end of the flexible printed circuit board is extended into the accommodating space 105 of the insulation housing 101, the cover body 102 may be pivoted and closed with respect to the insulation housing 101, such that it is pressed against the flexible printed circuit board and the conductive pins on the flexible printed circuit board are in contact with contact portions 104 of the terminals 103 on the cover body 102.

However, in the implementation of the embodiments of the present invention, the applicant found that defects existed in the prior art, since the FPC connector of such a hinge structure needs a gasket or a film to be added at the top to prevent hinge rebounding (i.e. being not locked firmly).

FIG. 3 is a schematic diagram showing an FPC connector 100 with a gasket added as in the prior art. As shown in FIG. 3, the gasket 301 covers the FPC connector. However, using a gasket or a film, a problem of connection of the FPC resulted from unreliable contact of the conductive pins, with such a problem of connection of the FPC being more severe in cases of abnormal operations or use, for example, being dropped.

Furthermore, the FPC connector of such a hinge structure needs relatively large space, that is, extra space is needed in both vertical direction (see the parts shown by circles in FIG. 1) and horizontal direction (see the parts shown by circles in FIG. 2). Such a problem of extra spaces requirement needs to be solved for terminal devices as they are becoming smaller and smaller.

### SUMMARY OF THE INVENTION

The embodiments of the present invention provide a circuit board connector having a sliding structure, and a connecting method of circuit board, with the object being to press or loosen the circuit board through the sliding of a sliding cover body, realizing the reliable connection of the circuit board.

According a first aspect of the embodiments of the present invention, there is provided a circuit board connector, the circuit board connector including:

an insulation housing, including opposed left and right side walls and a bottom wall arranged between the left and right side walls, the left and right side walls and bottom wall forming an accommodating space accommodating a circuit board;

terminals arranged on the bottom wall of the insulation housing, the terminals having contact portions within the accommodating space;

runners arranged in parallel at the left and right side walls of the insulation housing; and

a sliding cover body, with the two ends of the sliding cover body being connected to the runners and sliding along the runners.

According a second aspect of the embodiments of the present invention, the left and right edges of the sliding cover body have sliding blocks, the sliding blocks being embedded in the runners, so that the sliding cover body slides along the runners through the sliding blocks.

According a third aspect of the embodiments of the present invention, the sliding blocks are in a shape of a cylinder.

According a fourth aspect of the embodiments of the present invention, the circuit board connector further includes a supporting body arranged under the sliding cover body, the supporting body including:

a bottom end fixed to the bottom wall of the insulation housing;

a contact end arranged corresponding to the terminals; and

a free end arranged opposite to the contact end, the supporting body forming a “T” shaped structure through the free end, the contact end and the bottom end.

According a fifth aspect of the embodiments of the present invention, the contact end has a projection through which the supporting body clasps the circuit board.

According a sixth aspect of the embodiments of the present invention, the runners are in a shape of an arc.

According a seventh aspect of the embodiments of the present invention, there is provided a connecting method of circuit board, in which the above-described circuit board connector is used, the connecting method including:

extending the circuit board into an accommodating space of the circuit board connector, with the conductive pins of the circuit board corresponding to a contact portion of a terminal of the circuit board connector; and

sliding a sliding cover body of the circuit board connector against the circuit board, such that the conductive pins of the circuit board are in contact with the contact portion of the terminal and thus electrically connected to it.

According a ninth aspect of the embodiments of the present invention, the accommodating space is formed by opposed left and right side walls in the insulation housing of the circuit board connector and a bottom wall arranged between the left and right side walls; and the sliding cover body slides along runners arranged at the left and right side walls;

exposing the sliding cover body from the accommodating space before the circuit board is extended into the accommodating space, such that the conductive pins of the circuit board correspond to the contact portion of the terminal after the circuit board is extended into the accommodating space; and

the sliding cover body is pressed downwards after the circuit board is extended into the accommodating space, such that the conductive pins of the circuit board are in contact with the contact portion of the terminal and thus electrically connected to it.

According a tenth aspect of the embodiments of the present invention, the sliding cover body slides along the runners through sliding blocks at the left and right edges.

According a eleventh aspect of the embodiments of the present invention, the circuit board connector further includes a supporting body having a bottom end, a free end and contact end;

the sliding cover body is pressed against the free end before the circuit board is extended into the accommodating space, such that the accommodating space is formed between the contact end and bottom end of the supporting body; and

the sliding cover body is pressed against the contact end after the circuit board is extended into the accommodating space, such that the conductive pins of the circuit board are in contact with the contact portion of the terminal and thus electrically connected to it.

According a twelfth aspect of the embodiments of the present invention, a projection of the contact end clasps the circuit board after the sliding cover body is pressed against the contact end.

The advantages of the present invention exist in that the circuit board is pressed or loosened through the sliding of the sliding cover body, thereby realizing the connection of the circuit board, with no need of a gasket or a film, and with no need of an extra space.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### DESCRIPTION OF THE ACCOMPANYING DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a schematic diagram showing a state in which an FPC connector has not been fully coupled to the flexible printed circuit board in the prior art;

FIG. 2 is a schematic diagram showing a state in which an FPC connector has been fully coupled to the flexible printed circuit board in the prior art;

FIG. 3 is a schematic diagram showing an FPC connector with a gasket or a film added in the prior art;

FIG. 4 is a schematic diagram of the structure of an FPC connector of an embodiment of the present invention;

FIG. 5 is a schematic diagram of the runners of an embodiment of the present invention;

FIG. 6 is a schematic diagram of an embodiment of the present invention in which the edges of the sliding cover body have sliding blocks;

FIG. 7A is a schematic diagram showing a state of an embodiment of the present invention in which the sliding cover body is in a first position before the flexible printed circuit board is connected;

FIG. 7B is a schematic diagram showing a state of an embodiment of the present invention in which the sliding cover body is in a second position after the flexible printed circuit board is extended into an accommodating space;

FIG. 8 is a schematic diagram showing the runners of an embodiment of the present invention which are in a shape of an arc; and

FIG. 9 is a flowchart showing the connecting method of circuit board of an embodiment of the present invention.

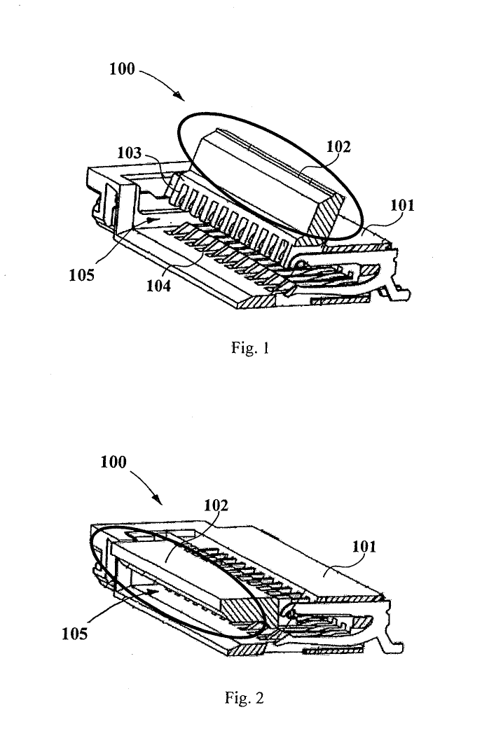

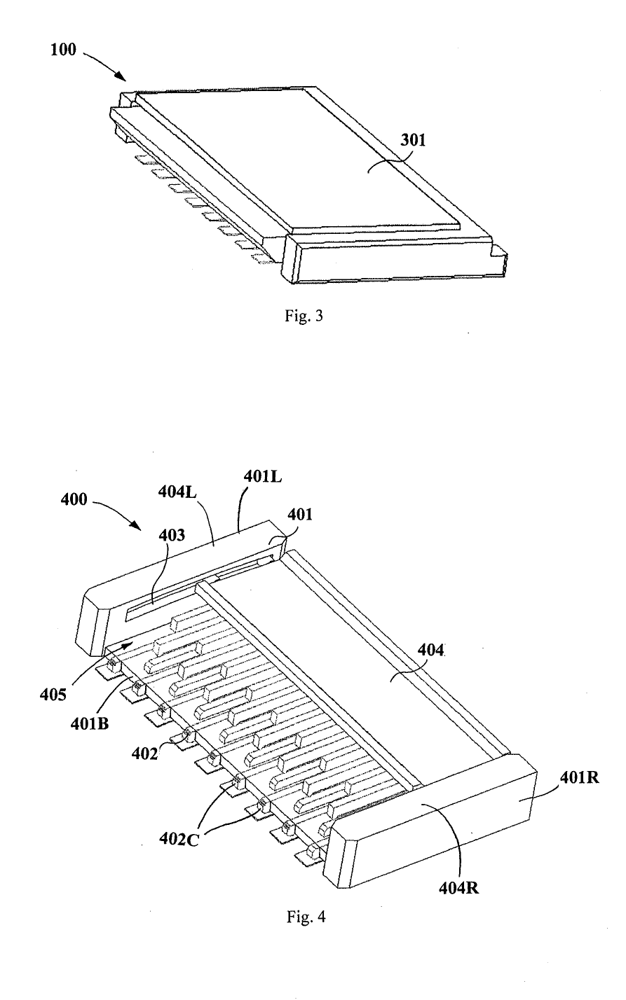

### DETAILED DESCRIPTION OF THE INVENTION

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the invention are described primarily in the context of a portable electronic device in the form of a mobile telephone (also referred to as “mobile phone”). However, it shall be appreciated that the invention is not limited to the context of a mobile telephone and may relate to any type of appropriate electronic apparatus, examples of such electronic apparatus including a media player, gaming devices, a PDA, a computer, and a digital video camera, etc.

In this embodiment of the present invention, the circuit board connector may be a flexible printed circuit (FPC) board connector, and the circuit board may be a flexible printed circuit board. However, the present invention is not limited thereto, and is applicable to other circuit board connectors in implementation. Following description is provided taking an FPC connector as an example.

The preferred embodiments of the present invention are described as follows in reference to the drawings.

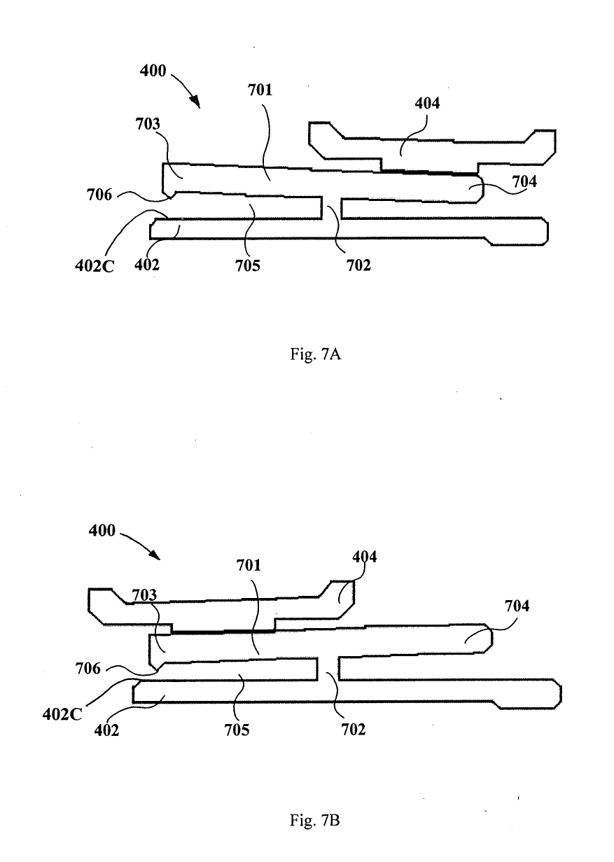

FIG. 4 is a schematic diagram of the structure of an FPC connector 400 of an embodiment of the present invention. As shown in FIG. 4, the FPC connector includes an insulation housing 401, a plurality of terminals 402 (which are illustrated in further detail in FIGS. 7A and 7B, described below), two runners 403, and a sliding cover body. The insulation housing 401 includes opposed left and right side walls 401L, 401R and a bottom wall 401B arranged between the left and right side walls, the left and right side walls and bottom wall forming an accommodating space 405 for accommodating a flexible printed circuit board.

A plurality of terminals 402 are arranged on the bottom wall 401B of the insulation housing 401, each terminal having a contact portion which is within the accommodating space.

The two runners 403 are arranged in parallel at the left and right side walls 401L, 401R of the insulation housing 401.

A sliding cover body 404, with the two ends 404L, 404R of the sliding cover body is connected to the runners 403 and sliding (slidable) along the runners 403.

In this embodiment, the sliding cover body 404 may have a first position and a second position and may slide between the first and second positions through the runners 403.

FIG. 4 shows a state in which the sliding cover body 404 is in a first position. As shown in FIG. 4, the sliding cover body 404 is exposed from the accommodating space 405 in the first position, so that the flexible printed circuit board may be extended into the accommodating space; and after the flexible printed circuit board is extended or placed into the accommodating space, the conductive pins (terminals) of the flexible printed circuit board may correspond to (e.g., align with) the contact portions 402C of the terminals 402.

Thereafter, the sliding cover body 404 may slide through the runners 403 and reach a second position. The sliding cover body 404 is pressed toward and applies pressure to the flexible printed circuit board in the second position, so that the conductive pins of the flexible printed circuit board are in contact with the contact portions 402C of the terminals 402 and thus electrically connected to them (also see FIGS. 7A and 7B, which are described below).

Thus, a reliable connection of the circuit board may be realized by pressing the flexible printed circuit board through the sliding of the sliding cover body. The flexible printed circuit board may be pressed with this sliding structure and there is no need to add a gasket or a film. And, as can be clearly seen from FIG. 4, the sliding cover body slides within the accommodating space 405 formed by the left and right side walls 404L, 404R and bottom wall 401B of the insulation housing, with no need of an extra space.

In an embodiment of the present invention, the left and right edges of the sliding cover body 404 may have sliding blocks, the sliding blocks being embedded into the runners 403, so that the sliding cover body 404 slides along the runners through the sliding blocks.

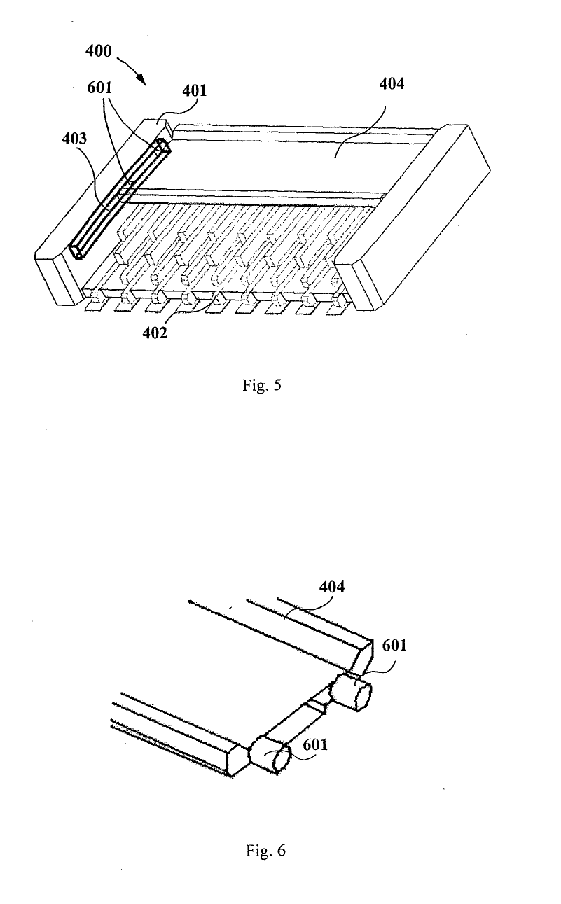

FIG. 5 is a schematic diagram of the runners 403, and FIG. 6 is a schematic diagram showing that the edges of the sliding cover body 404 have sliding blocks 601. As shown in FIG. 6, the sliding blocks 601 may be in a shape of a cylinder, and one or more sliding blocks may be arranged at left and right edges of the sliding cover body 404; however, the present invention is not limited thereto, and the particular shape and number of the sliding blocks may be determined as actually required.

Preferably, two sliding blocks 601 may be arranged at each side of the sliding cover body 404, and the sliding blocks 601 are in a shape of a cylinder. Here, in the integration of a mobile phone, the sliding cover body may be more easily pushed and will not be loosened when it is pressed.

As shown in FIG. 5, after the sliding blocks 601 of the sliding cover body 404 are embedded into the runners 403 at the left and right walls 401L, 401R of the insulation housing 401, the sliding cover body 404 may slide along the runners through use of the sliding blocks.

The above description of the sliding cover body in sliding is just illustrative; however, the present invention is not limited thereto, and particular implementation may be determined as actually required.

Furthermore, the embodiments of the present invention provide an FPC connector.

FIGS. 7A and 7B are sectional views of an FPC connector 400 of an embodiment of the present invention. FIGS. 7A and 7B only show schematically a part of the structure of the FPC connector, in which the bottom wall 401B (FIG. 4) of the insulation housing 401 is blocked by the terminals 402, and in which the insulation housing 401 and the runners 403 are not shown.

As shown in FIG. 7A, the FPC connector may further include a supporting body 701 arranged under the sliding cover body 404, a bottom end 702 fixed to the bottom wall 401B (FIG. 4) of the insulation housing 401, a contact end 703 arranged corresponding to the terminals 402, and a free end 704 arranged above the terminals 402 and corresponded to the contact end 703.

As shown in FIG. 7A, the sliding cover body 404 is arranged on the supporting body 701 and may slide between the contact end 703 and the free end 704. The supporting body 701 forms a “T” shaped structure through the bottom end 702, the contact end 703 and the free end 704. The “T” shaped structure may be integrally shaped using an elastic metal material; however, the present invention is not limited thereto. For example, pivots may be used at the connecting portions of the “T” shaped structure, such that the contact end 703 and the free end 704 are rotatable with relative to the bottom end 702, and particular implementation may be determined as actually required. Therefore, the supporting body 701 forms a structure like a teeterboard through the press of the sliding cover body 404.

FIG. 7A shows a state in which the sliding cover body 404 is in a first position before the flexible printed circuit board is connected. As shown in FIG. 7A, the sliding cover body 404 is pressed against the free end 704, such that the contact end 703 is lifted, and an accommodating space 705 is further formed between the contact end 703 and the bottom end 702, facilitating the insertion of the flexible printed circuit board.

After the flexible printed circuit board (not shown) is inserted into the accommodating space 705, the conductive pins of the flexible printed circuit board may correspond to (align with) the contact portion 402C of the terminal 402 of the circuit board connector; thereafter, the sliding cover body 404 may slide through the runners and reach a second position.

FIG. 7B shows a state in which the sliding cover body 404 is in the second position after the flexible printed circuit board is inserted into the accommodating space 705. As shown in FIG. 7B, the sliding cover body 404 is pressed against the contact end 703, such that the conductive pins of the flexible printed circuit board are in contact with the contact portion 402C of the terminal 402 and thus electrically connected to it.

Furthermore, as shown in FIGS. 7A and 7B, the contact end 703 may further have a projection 706, such that the projection 706 clasps the flexible printed circuit board after the sliding cover body 404 is pressed against the contact end 703. As shown in FIG. 7B, the projection 706 may lock firmly the flexible printed circuit board, preventing the flexible printed circuit board from being unlocked from the FPC connector in abnormal operation.

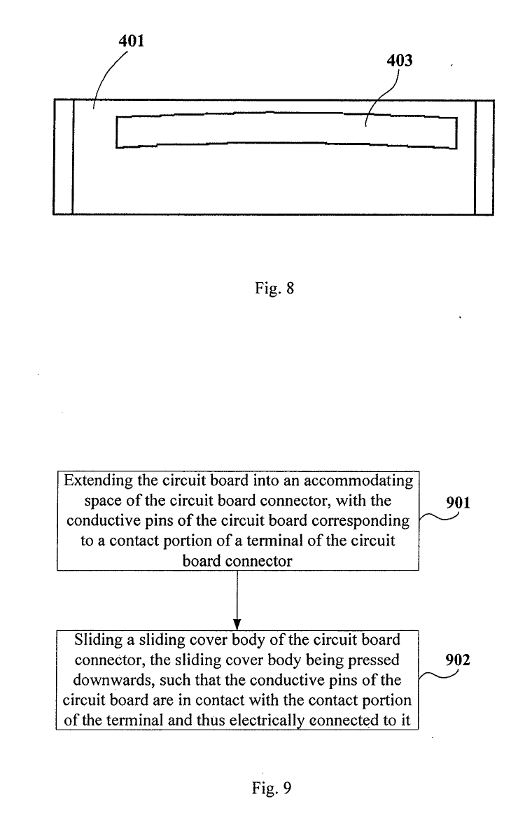

Furthermore, in an embodiment of the present invention, the runners 403 may be in a shape of an arc. FIG. 8 is a schematic diagram showing that the runners are in a shape of an arc. As shown in FIG. 8, when the sliding cover body 404 slides between the first and second positions, the moving track is in a shape of an arc, thereby forming a slope when it is pressed against the contact end, further pressing the contact end, so that the conductive pins of the flexible printed circuit board are in better contact with the contact portion of the terminal.

It can be seen from the above embodiments that the reliable connection of the flexible printed circuit board may be realized through the FPC connector having a sliding structure and the flexible printed circuit board is firmly pressed, with no need of a gasket or a film. And the sliding cover body slides within the space formed by the left and right side walls and bottom wall of the insulation housing, with no need of an extra space.

The embodiments of the present invention further provide a connecting method for circuit board, in which the above-described circuit board connector is used. FIG. 9 is a schematic diagram of the connecting method for circuit board of an embodiment of the present invention. As shown in FIG. 9, the connecting method includes:

step 901: extending the circuit board into an accommodating space of the circuit board connector, with the conductive pins of the circuit board corresponding to a contact portion of a terminal of the circuit board connector; and

step 902: sliding a sliding cover body of the circuit board connector, the sliding cover body being pressed downwards, such that the conductive pins of the circuit board are in contact with the contact portion of the terminal and thus electrically connected to it.

In an embodiment of the present invention, the accommodating space is formed by opposed left and right side walls in the insulation housing of the circuit board connector and a bottom wall arranged between the left and right side walls; and the sliding cover body slides along runners arranged at the left and right side walls;

exposing the sliding cover body from the accommodating space before the circuit board is extended into the accommodating space, such that the conductive pins of the circuit board correspond to the contact portion of the terminal after the circuit board is extended into the accommodating space; and the sliding cover body is pressed downwards after the circuit board is extended into the accommodating space, such that the conductive pins of the circuit board are in contact with the contact portion of the terminal and thus electrically connected to it.

Furthermore, the sliding cover body may slide along the runners through sliding blocks at the left and right edges.

In another embodiment, the circuit board connector may further include the supporting body as described above; and the connecting method may further include:

pressing the sliding cover body against the free end of the supporting body of the circuit board connector before the circuit board is extended into the accommodating space, such that the accommodating space is formed between the contact end and bottom end of the supporting body; and pressing the sliding cover body against the contact end after the circuit board is extended into the accommodating space, such that the conductive pins of the circuit board are in contact with the contact portion of the terminal and thus electrically connected to it.

Furthermore, the circuit board may be clasped by a projection of the contact end after the sliding cover body is pressed against the contact end.

It can be seen from the above embodiments that the reliable connection of the flexible printed circuit board may be realized through the FPC connector having a sliding structure and may firmly press the flexible printed circuit board, with no need of a gasket or a film. And the sliding cover body slides within the space formed by the left and right side walls and bottom wall of the insulation housing, with no need of an extra space.

The preferred embodiments of the present invention have been described above with reference to the accompanying drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present invention by using the apparatus.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A circuit board connector, comprising:
an insulation housing, comprising opposed left and right side walls and a bottom wall arranged between the left and right side walls, the left and right side walls and bottom wall forming an accommodating space accommodating a circuit board;
terminals arranged on the bottom wall of the insulation housing, the terminals having contact portions which is within the accommodating space;
runners arranged in parallel at the left and right side walls of the insulation housing; and
a sliding cover body, with the two ends of the sliding cover body being connected to the runners and sliding along the runners.

2. The circuit board connector according to claim 1, wherein the left and right edges of the sliding cover body have sliding blocks, the sliding blocks being embedded into the runners, so that the sliding cover body slides along the runners through the sliding blocks.

3. The circuit board connector according to claim 2, wherein the sliding blocks are in a shape of a cylinder.

4. The circuit board connector according to claim 1, wherein the circuit board connector further comprises a supporting body arranged under the sliding cover body, the supporting body comprising:
a bottom end fixed to the bottom wall of the insulation housing;
a contact end arranged corresponding to the terminals; and
a free end arranged opposite to the contact end, the supporting body forming a “T” shaped structure through the free end, the contact end and the bottom end.

5. The circuit board connector according to claim 4, wherein the contact end further has a projection through which the supporting body clasps the circuit board.

6. The circuit board connector according to claim 4, wherein the runners are in a shape of an arc.

7. A connecting method of circuit board, in which the circuit board connector as claimed in claim 1 is used, the connecting method comprising:
extending the circuit board into an accommodating space of the circuit board connector, with the conductive pins of the circuit board corresponding to a contact portion of a terminal of the circuit board connector; and
sliding a sliding cover body of the circuit board connector, the sliding cover body being pressed downwards, such that the conductive pins of the circuit board are in contact with the contact portion of the terminal and thus electrically connected to it.

8. The connecting method according to claim 7, wherein the accommodating space is formed by opposed left and right side walls in the insulation housing of the circuit board connector and a bottom wall arranged between the left and right side walls; and the sliding cover body slides along runners arranged at the left and right side walls;
exposing the sliding cover body from the accommodating space before the circuit board is extended into the accommodating space, such that the conductive pins of the circuit board correspond to the contact portion of the terminal after the circuit board is extended into the accommodating space; and
the sliding cover body is pressed downwards after the circuit board is extended into the accommodating space, such that the conductive pins of the circuit board are in contact with the contact portion of the terminal and thus electrically connected to it.

9. The connecting method according to claim 7, wherein the sliding cover body slides along the runners through sliding blocks at the left and right edges.

10. The connecting method according to claim 7, wherein the circuit board connector further comprises a supporting body having a bottom end, a free end and contact end;
the sliding cover body is pressed against the free end before the circuit board is extended into the accommodating space, such that the accommodating space is formed between the contact end and bottom end; and
the sliding cover body is pressed against the contact end after the circuit board is extended into the accommodating space, such that the conductive pins of the circuit board are in contact with the contact portion of the terminal and thus electrically connected to it.

11. The connecting method according to claim 10, wherein a projection of the contact end clasps the circuit board after the sliding cover body is pressed against the contact end.
